(19) United States
(12) Patent Application Publication
(10) Pub. No.: US 2008/0193908 A1
(43) Pub. Date: Aug. 14, 2008

(54) Faculty workstation

(76) Inventors: James Wang, Chatham, NJ (US); Anthony Ma, Great Neck, NY (US)

Correspondence Address: COOPER & DUNHAM, LLP, 1185 AVENUE OF THE AMERICAS, NEW YORK, NY, 10036, US

(21) Appl. No.: 11/704,433

(22) Filed: Feb. 8, 2007

(51) Int. Cl. G09B 19/00

(52) U.S. Cl. 434/365

(57) ABSTRACT

Software based tools are provided to course instructors in an educational community to enable an instructor to access content of a plurality of academic courses from an information terminal. A user interface displays a class list and a list of tasks, and allows the instructor to select a plurality of classes from the displayed class list and select a task from the displayed list of tasks. In response to user entry of a single command through the user interface, a processing part causes the selected task to be performed to course content for each of the plurality of selected classes. Thus, the instructor can add or modify content to each of the plural selected classes through a single command entered through the information terminal.

### TECHNICAL FIELD

This application relates to accessing and modifying content for a course, class or section via a network. In particular, the application relates to methods, apparatuses and systems for enabling faculty members or course instructors to perform a task to/on course content for a plurality of educational courses, classes or course/class sections.

### DESCRIPTION OF THE RELATED ART

The use of information technology (IT) is proliferating across many (if not all) segments of society. IT is popularly used by commercial enterprises in many shapes and forms, such as to facilitate intra-office or inter-office communications, facilitate communications with customers and vendors, provide IT-based products and/or services, etc.

Many have also proposed IT-based systems for online access to academic content. Some educational institutions provide courses or classes through a virtual classroom (or lecture hall) over the Internet. Many educational institutions provide course/class content (such as assignments, announcements, course materials, chat and whiteboard facilities, and the like) accessible to the students over the Internet. Thus, an educational or course instructor (for example, a professor, a teaching assistant, a teacher in a secondary educational institution, an administrator in an educational institution, etc.) can interact with one or more students by transmitting course lectures, textbooks, literature, and other course materials, receiving student questions and input, and conducting participatory class discussions over the Internet.

In addition, an open platform system has been proposed such that anyone with access to the Internet can create, manage, and offer a course to anyone else with access to the Internet, without the need for an affiliation with an institution, thus enabling the virtual classroom to extend worldwide.

However, the proposed systems generally present content in a course-centric manner. That is, the approach of the presentation by the system is typically founded on the assumption that when a user (such as a faculty member) signs onto the system, the user only wishes to use the system for a single course or class at a time, and therefore previously proposed systems merely allow the instructor to post or access course content one course, class or section at a time.

The proposed system fail to embody the recognition that a course instructor who is providing instruction for multiple courses, classes (for example, same course offered by different departments) or sections (for example, same class or course at different time slots or on different campuses) can have a need to perform the same task for multiple courses, classes or sections. For example, the faculty member may wish to maintain consistency of content and/or process across several similar classes or multiple sections of a class. The proposed systems do not provide the facilities to meet this need.

### SUMMARY

This disclosure provides various tools which allow improved workflow on an information terminal for course instructors and faculty members of an educational community. The tools enable the course instructor or faculty member to post or retrieve class or course-related information, and add or modify class/course content for each of a plurality of classes selected by the course instructor or faculty member, through a single command entered through an information terminal.

For example, the tools can allow an authorized user to post a file (for example, an assignment, syllabus, announcement, etc.) to shared folders of multiple classes by selecting the file and uploading to multiple classes or sections at the same time, as opposed to manually repeating the upload process multiple times (once per class). In another example, a faculty member can send email to all his/her students in multiple class sections, without entering (or even selecting) the e-mail address of each student.

### BRIEF DESCRIPTION OF THE DRAWINGS

The features of the subject matter of this disclosure can be more readily understood from the following detailed description with reference to the accompanying drawings wherein:

FIG. 1A shows a block diagram of a system for faculty members of an educational community to access and modify content of a plurality of academic courses, according to an exemplary embodiment of the present disclosure;

FIG. 1B shows a flow chart of a method for enabling faculty members of an educational community to access and modify content of a plurality of academic courses, in accordance with an exemplary embodiment of the present disclosure;

FIG. 1C shows a block diagram of a system according to a second exemplary embodiment of this disclosure (wherein a faculty workstation application is provided as a service through a network or point-to-point connection to an information terminal);

FIG. 1D shows a block diagram of a system according to a third exemplary embodiment of this disclosure (wherein a thin client is provided on the information terminal);

FIG. 2 shows a block diagram of an information terminal which can be used in the system shown in FIG. 1C, or on which the faculty workstation shown in FIG. 1A can be implemented; and

FIGS. 3A through 3U illustrate exemplary user interface screens.

### DETAILED DESCRIPTION

This specification describes a number of tools which can be provided to enable faculty members to access information pertinent to his/her courses (that is, classes taught by the faculty member, or for which the faculty member otherwise has responsibilities for the content thereof), and add, build, copy, create, delete, edit, find, generate, import, manage, open, post, provide, publish, rename, unpublish, update, upload and view content, while allowing the faculty member to avoid repetition of tasks where possible. The basic approach is to allow a course instructor or faculty member to access information pertinent to his/her classes from a single entry point. This is a shift from the class/course-centric workflow (wherein course content for a particular class, course or section is assembled as a collection of information specific to only that class, course or section) to a user-centric workflow wherein repetition of tasks can be streamlined to save “clicks” by specifying a task once, and applying the task to multiple classes, courses and/or sections. As with any organization (academic, private sector business, public sector service, etc.), technology should provide tools that allow users to work “smarter”, so that more can be accomplished in less time. The subject matter of this disclosure provides faculty users with the ability to accomplish this objective, through tools that can significantly cut the amount of time it takes to complete otherwise repetitive tasks.

Some preferred embodiments of the subject matter of this disclosure are described herein. In describing preferred embodiments, specific terminology is employed for the sake of clarity. However, the disclosure of this patent specification is not intended to be limited to the specific terminology so selected and it is to be understood that each specific element includes all technical equivalents that operate in a similar manner.

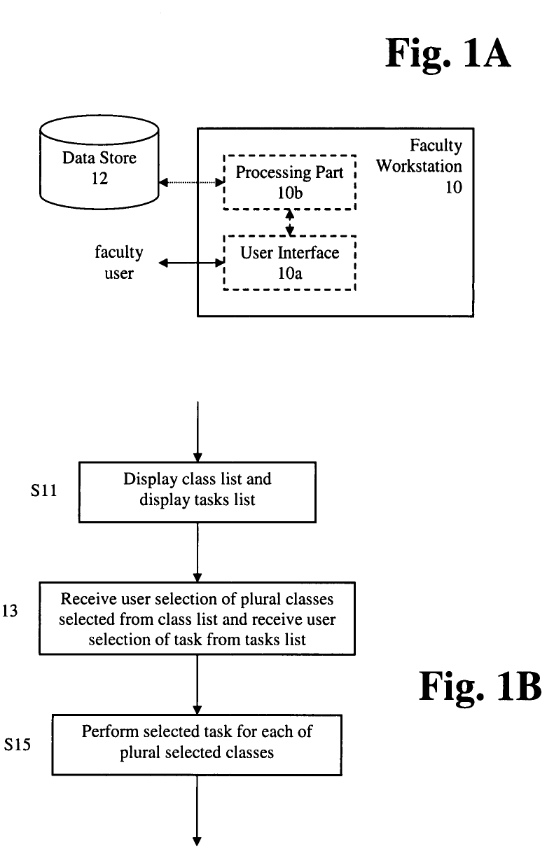

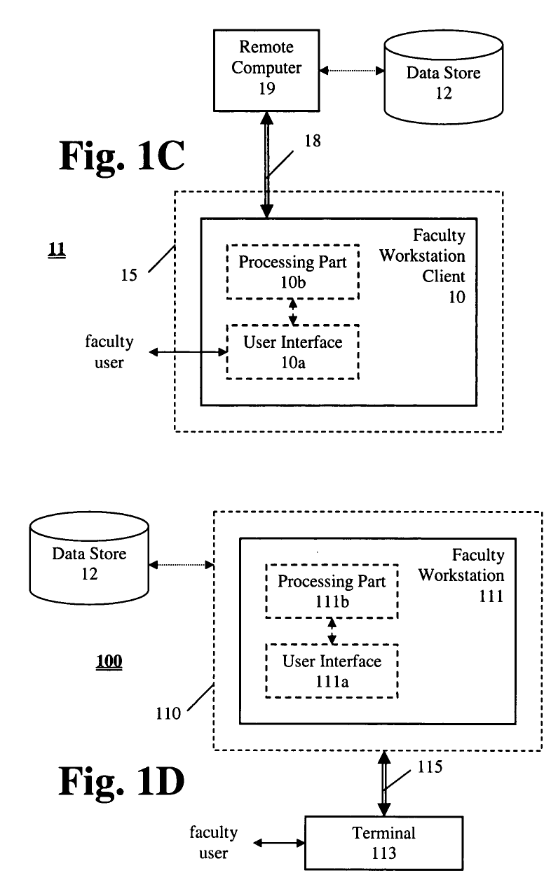

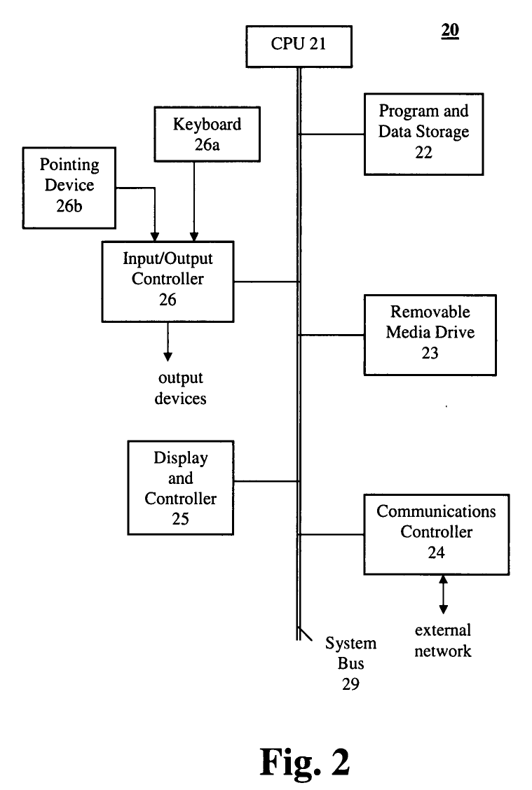

A system for a faculty member of an educational community to access and modify content of a plurality of academic courses, according to an exemplary embodiment of this disclosure, is shown in FIG. 1A. System 1 includes a faculty workstation 10 coupled to data store 12 directly or indirectly (that is, through a server or another computer that maintains the data store, via a network). The faculty workstation 10 includes a user interface 10a and a processing part 10b. The user interface 10a is configured to receive user commands and present, interactively, assorted types of class/course content and assorted choices of tasks that can be performed through the faculty workstation to selected class/course content. The processing part 10b, based on user command, performs selected tasks to selected content. As mentioned supra, the faculty workstation apparatus can be manifested in any of various configurations, such as an application executing on an information terminal (for example, FIG. 2).

An overview of a basic process for enabling course instructors in an educational community, to add or modify class/course content of a plurality of academic courses, according to an embodiment of this disclosure, is discussed below with reference to FIGS. 1A and 1B. Generally, the user interface 10a displays a class list and displays a tasks list (step S11). The course instructor or faculty user, using the user interface 10a at the faculty workstation 10, selects a plurality of classes from the displayed class list via a user interface and selects a task from the displayed task (step S13). Data indicating the selected task and the plurality of selected classes is passed to the processing part 10b, and the processing part 10b performs the selected task for each of the selected classes (step S15). The faculty only needs to go through the process of specifying a command once for the selected task, and the selected task is then performed to/on the content for each of the plural selected classes (or courses, sections, etc.) in turn or simultaneously.

The tools are preferably software-based, and can be implemented as an application executing on an information terminal (for example, personal or notebook computer, PDA, information appliance configured with a display and for network communication, etc.), residing natively on the informational terminal or received as a service from a server on a client-server basis, or from a remote computer on a peer-to-peer basis. Any one or more of the conventional programming techniques and paradigms (for example, HTML, XML, Java, etc.) can be utilized to implement functionalities for the tools. Since at least some of the possible exemplary embodiments of the subject matter of this disclosure involve communications over a network, the tools will conform, to the extent necessary and/or desirable, to standard protocols that have been adopted for such communications. It should be appreciated of course that the subject matter of this disclosure is not limited to any particular one or group of the programming techniques and communication protocols, and that non-standard programming techniques and/or communication protocols can be used as well.

A system 11, according to another exemplary embodiment of this disclosure, is shown in FIG. 1C. In the system 11, a faculty workstation application 10 is provided through a network or point-to-point connection 18 to an information terminal 15 from remote computer 19. The remote computer 19 can be a server computer providing the faculty workstation application to any of a plurality of authorized information terminals through a network, as one example. For example, the information terminal establishes a point-to-point connection (either a high-bandwidth connection or a dial-up connection) with the remote computer 19, and the faculty user utilizing the faculty workstation application can access the desired content.

In another exemplary embodiment (FIG. 1D), a system 100 is configured such that faculty workstation application 111 is provided through an ASP (application service provider) via a server 110 (or a cluster of servers) through a network or point-to-point connection 115 to an information terminal 113 via a thin client. The information terminal 113 can be configured as a dumb terminal or as shown exemplarily in FIG. 2. Processing part 111b performs all of the required processing on the server end. User interface 111a is configured to provide the appropriate information for display on the information terminal 113. For example, in a preferred embodiment, the faculty workstation application is provided as one of various applications available through a web portal serviced by server 110, and the faculty user using a web browser can access, following appropriate login, the assorted content available through the faculty workstation application. The processing part 111b processes data received through the user interface 111a from the remote information terminal 113, including user selection of classes and tasks. The user interface 111 a facilitates suitable communication of information regarding user selections of tasks and classes, and information regarding content to be added, modified, etc., and processes data to be transmitted to the remote information terminal 113, in order to facilitate presentation of class information, task information, content to be modified, and other information and messages

Various features can be provided through the faculty workstation to facilitate modification and/or addition of informational content to course content for selected classes. For example, the faculty workstation can enable the faculty user to add, build, copy, create, delete, edit, find, generate, import, manage, open, post, provide, publish, rename, unpublish, update, upload and view content, as well as set defaults for operations. Some of the various types of informational content on which a selected task can be performed include: assignments; announcements; schedules; academic discussion forums; student journals; gradebook; lessons; syllabus; attendance records; shared files; bookmarks; e-mails; journal entries; and summary of student access to tracked areas.

For example, the following is merely a small sample of the many features that may be provided: adding a new assignment; adding a new gradebook item; adding a new event; adding a new lesson; adding a new message board topic; adding an attendance sheet; adding a new shared file; adding a new bookmark; adding a new journal entry; adding a syllabus; and adding a new announcement.

The informational content may be pre-prepared external to the facility workstation. The user specifies through the user interface the informational content to be uploaded by the processing part, and the uploaded informational content is posted to course content for each of the plurality of selected classes, in response to a single command from the user through the user interface.

On the other hand, the informational content may be entered by the user through the user interface, and the user-entered informational content can be posted to course content for each of the plurality of selected classes or transmitted by e-mail to all members of the plurality of selected classes, in response to a single command from the user through the user interface.

Facilities may be provided through the faculty workstation for synchronizing content across a plurality of selected classes. For example, the user specifies through the user interface an element or component (for example, assignments; announcements; attendance records; academic discussion forums; bookmarks; e-mails; gradebook; lessons; schedules; shared files; student journals; syllabus; journal entries; etc.) to be included in course content of each of the plurality of selected classes, and the processing part synchronizes the specified element or component across the course content of the each of the plurality of selected classes.

The process can be simplified for the faculty member to identify the relevant classes by displaying a list of academic terms for user selection, and compiling the class list based on one or more terms selected by the user from the list of academic terms.

An exemplary embodiment of the subject matter of this disclosure is described below, in the form of a Faculty Workstation apparatus.

The Faculty Workstation can be configured for network access to post or retrieve class or course-related information. A faculty user is preferably provided with the option of accessing Faculty Workstation facilities through a Web portal. A login process which provides for user authentication and establishes the user's access rights is of course also preferred. Since such authentication and authorization processes are well-understood in the art, this disclosure does not include a detailed of such processes, in the interest of clarity.

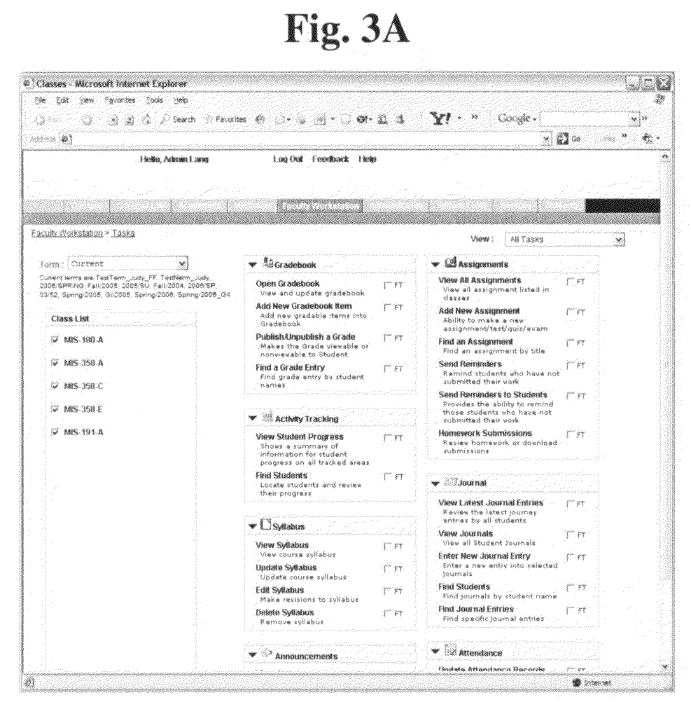

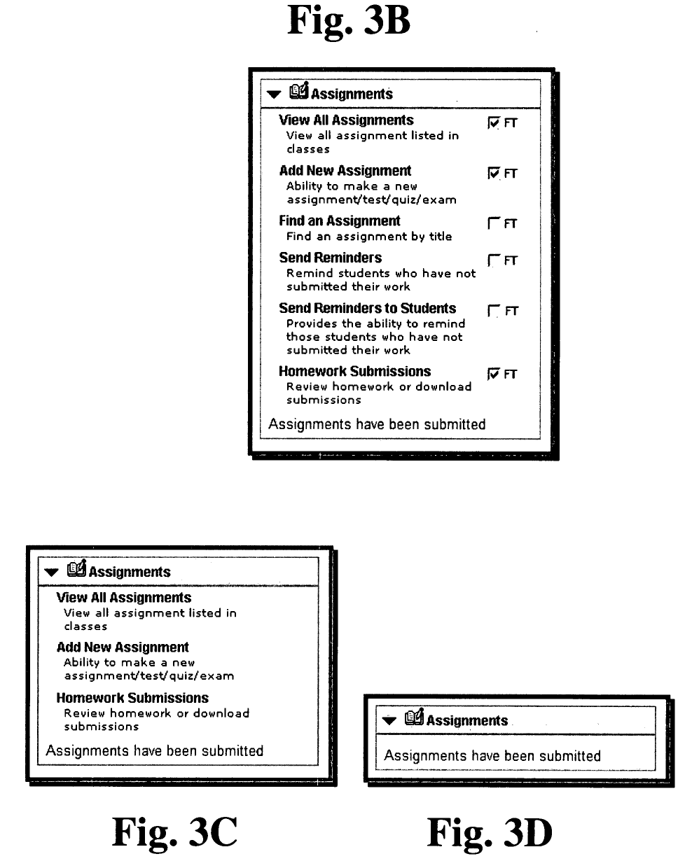

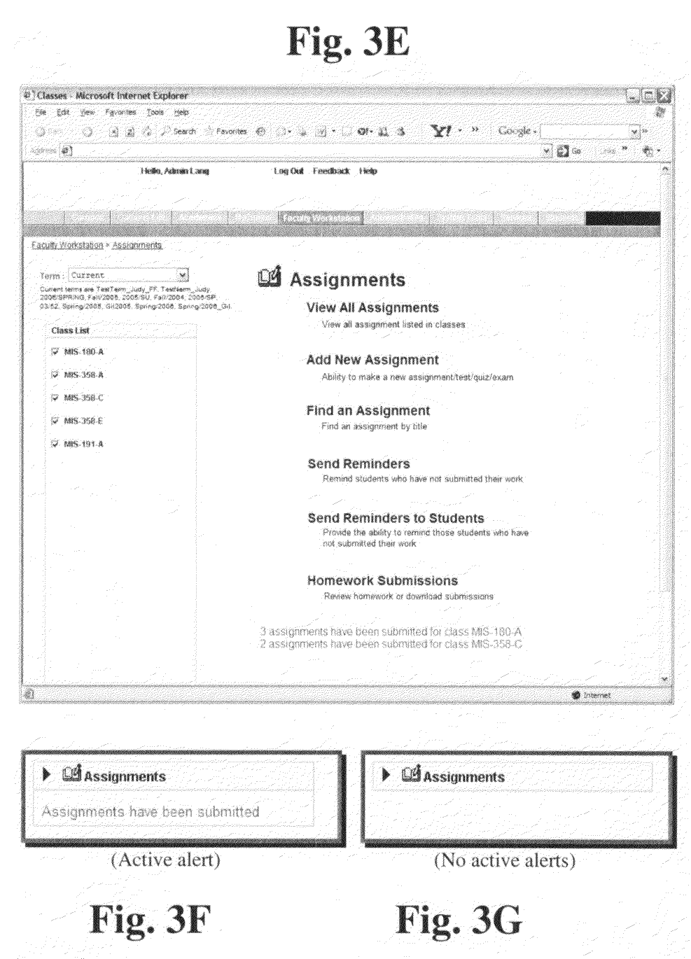

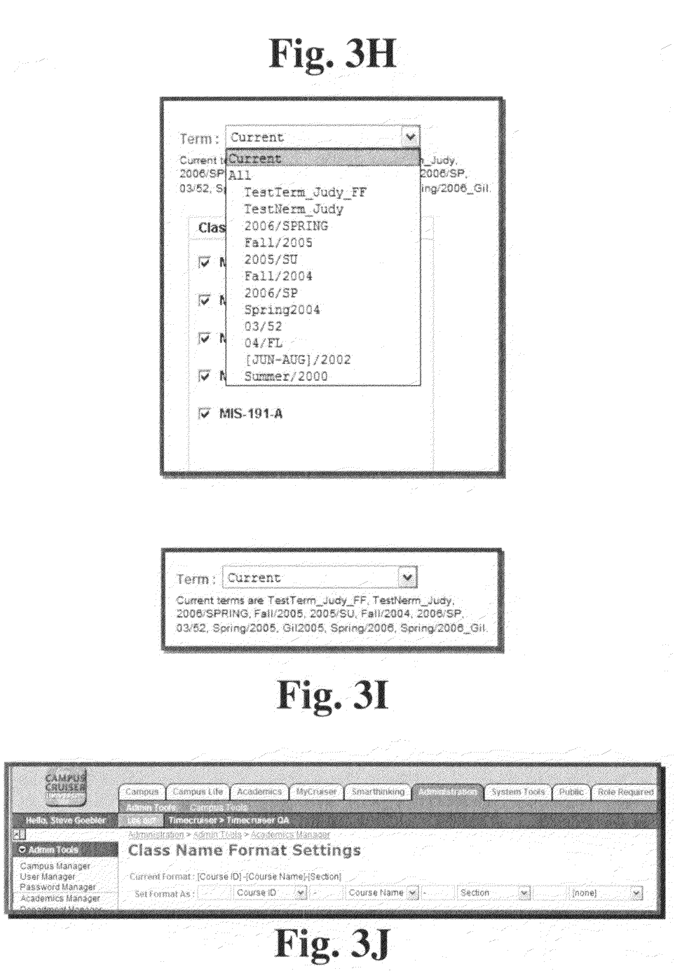

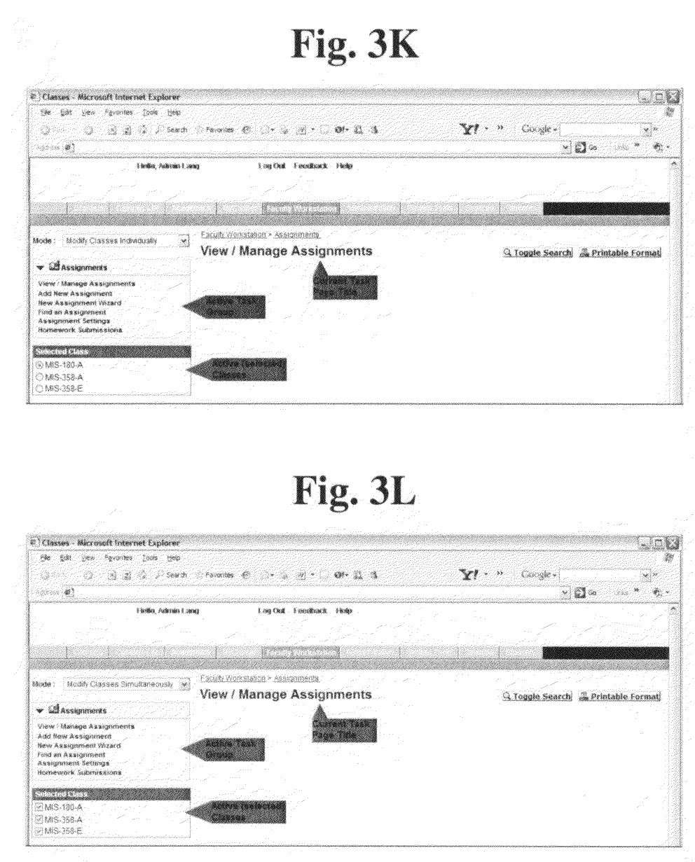

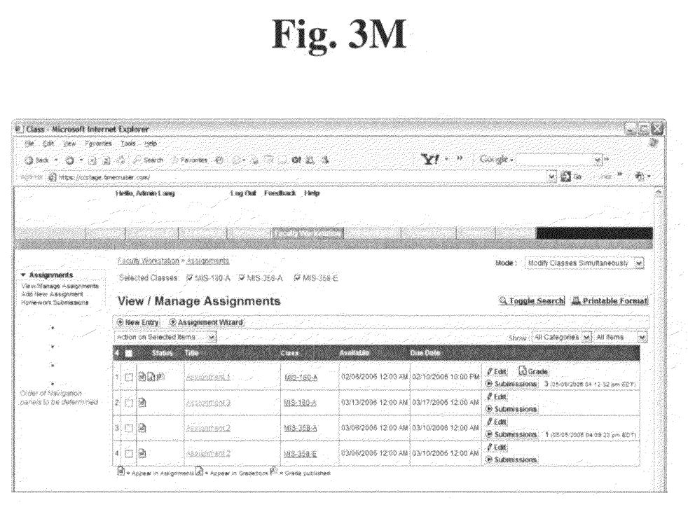

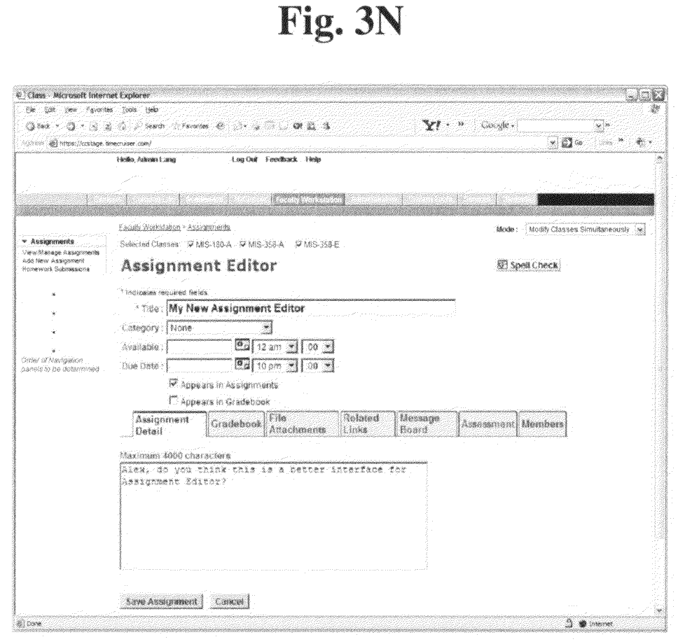

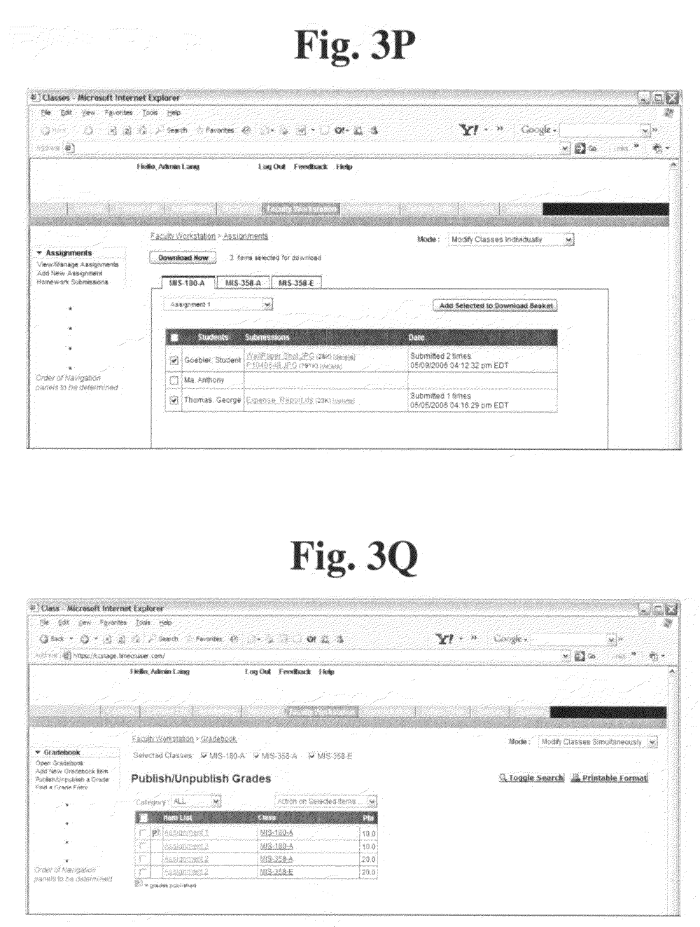

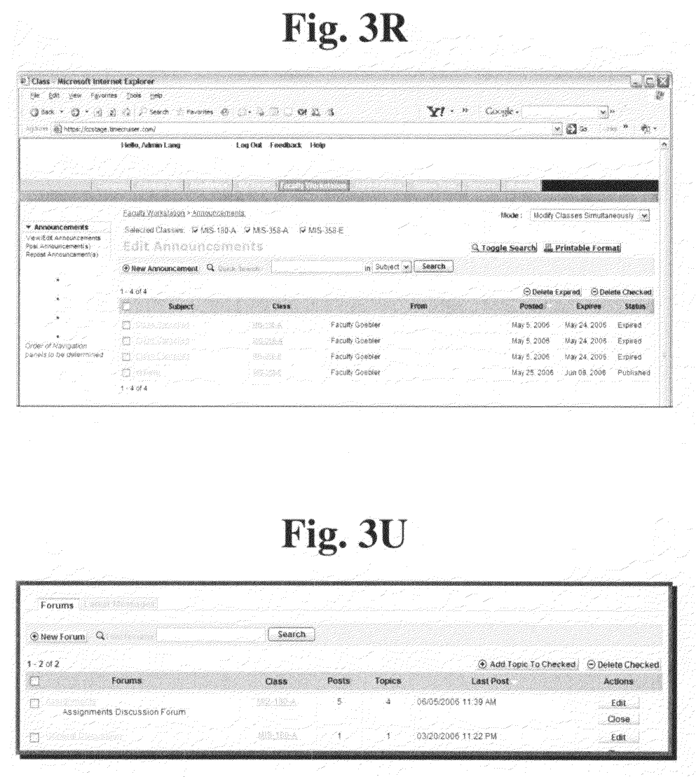

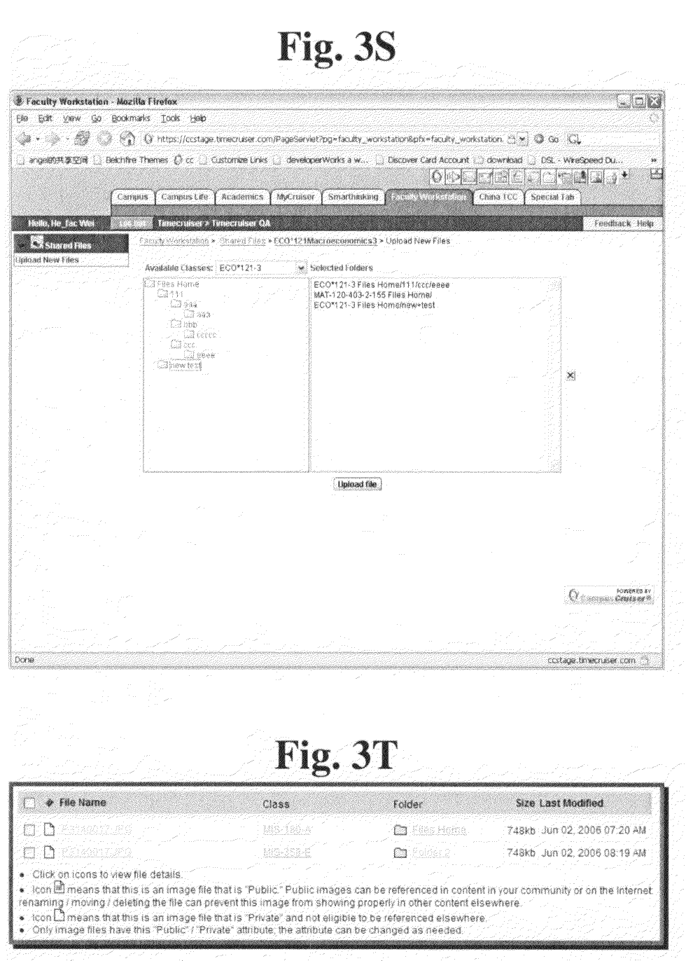

Upon login to the Faculty Workstation, the faculty member is presented with a view (for example, FIG. 3A) of a list of classes (Class List) for which information is available and tasks which can be selectably performed. In the example of FIG. 3A, a Term selection drop-down menu and is also presented. Each time the Faculty Workstation is accessed, the default Term is “Current” and all classes in the Class List are selected.

The Class List allows the faculty member to select one or multiple classes for which selected tasks are to be performed. By default, all classes are selected (to allow for alerts from the Classes Application to post to the task groups)

The view upon login (FIG. 3A) can also present available tasks that can be performed. Tasks can be grouped as sets based (loosely) on tool functions. For example, the Gradebook task group contains such items as Open Gradebook, Add New Gradebook Item, Publish/Unpublish a Grade, Find a Grade Entry, etc.

Each task listed can be a hot link to the work page of the task. If a task is clicked without having selected at least one class from the Class List, a pop-up window can be presented with a warning message such as “No class has been selected for this task. Please select at least one class from the Class List.”

The title of each task group can be selectable. Clicking on the title of the task group can launch information corresponding to the task group into a “full page view” (for example, FIG. 3E). The default for first time viewing is to display for each group all tasks of the group. However, the displayed tasks can be customizable, as explained below.

A View selection drop-down box can be presented. This drop-down box allows the user to select a desired view of the task groups, such as “All Tasks”, “Frequent Tasks”, etc. By default, All Tasks is selected. In the All Tasks view, each task is accompanied by an FT checkbox.

When the FT box corresponding to a task is checked, the task is also shown in a Frequent Task view. Selecting the “Show Frequent” in the drop-down box changes the display of the task groups and removes the “FT” check boxes from the view within the task groups. When selecting items to customize the Frequent Task view, each selection is automatically saved.

In the example above, the FT checkboxes are checked by the user and the user selections are saved. In addition, in another example, the selection of the boxes can also be automatic (that is in addition, to user selection) for tasks that have been recently performed (for example, last performed less than a predetermined period of time ago or within a predetermined number of previous logins).

In addition, view selections can be registered by the system for the user. That is, if the user has selected the Frequent Tasks view, when the user accesses Faculty Workstation the next time, the Frequent Tasks view is automatically launched.

In the example of FIG. 3B, the Assignments task group has View All Assignments”, “Add New Assignment” and “Homework Submissions” selected as FT.

If Frequent Tasks is selected from the drop-down, the display of the task groups is adjusted accordingly. Using the Assignment task group as an example, the display appears as shown in FIG. 3C.

In the event that Frequent Tasks is selected and none of the tasks with a group are selected as “FT”, the task group is collapsed, with the Title Bar and any system alerts belonging to the task group being displayed (for example, FIG. 3D).

Optionally, Hide/View Task Descriptions button may be included, to enable the user to indicate whether to show or hide task descriptions beneath each task item for example, “View all assignment listed in classes” appearing beneath “View All Assignments” task item in FIG. 3C, etc.).

As stated earlier, clicking on the Title of a task group can launch a separate task group page, regardless of the selection view of the task group (that is, All Tasks, Frequent Tasks, collapsed view, etc.) in use. For example, selecting the Assignments title launches the page shown in FIG. 3E.

The title bar of each task group is equipped with a “Twisty” (see top left corner of view in FIG. 3B).

Twisties allow for the expanding/collapsing of the task group to display/hide the tasks within the group. This is similar to the View All Tasks/Frequent Tasks drop-down, with a few exceptions.

Twisties operate independent of the View All Tasks/Frequent Tasks drop-down. That is, no matter the view that is selected (All Tasks or Frequent Tasks), the twisty, when triggered, collapses or expands the view (based on the page view selected). That is, if the page is in “View All Tasks” mode, the twisty, when pointing down (expanded view) displays all of the task items within the group (for example, FIG. 3B).

If the viewing mode is set to “Frequent Tasks”, a group can appear as shown, for example, in FIG. 3C.

In the collapsed view (twisty pointing to the right), in either viewing mode, the group appears as the title bar with only alerts displayed (that is, alerts display even if the view of the group is collapsed), such as shown in, for example, FIG. 3F (with active alert) and FIG. 3G (no active alert).

The Term Selection Drop-down box allows the user to select one or multiple terms for which classes are to be listed in the Class List selection area. The default term is “Current”. However, any term or all terms can be selected (FIG. 3H). Changing the selection of term results in an updated list of classes (based on the selected term or terms) with the checkbox of all listed classes selected. A list of “current” terms is provided beneath the drop down box (FIG. 3I).

The Class selection panel (“Class List”) contains all of the classes that the faculty member teaches (however, if the faculty user is participating in a class as a student, that class is not presented in this list). It is from this list that the user selects the classes for which selected tasks are performed.

Selection of classes are cached for the session, and returning to the task selection page results in display of classes as selected, as long as the user does not log-out.

When a new term is selected, all of the classes for the new term are displayed and selected. The settings for the term that was previously displayed revert back to the default (all selected) if the user returns to that term. For example, if in the “Current” term, the user de-selects classed MIS-358-C, and MIS-358-E and then switches to term “Summer/2000” which is not part of the “current terms” list (see FIG. 3I). Upon returning to the current term, all classes appear as selected, including MIS-358-C and MIS-358-E, which were deselected previously.

The Class List shows the Class Names based on Class Name format specified by an administrator (See FIG. 3J). Class Names listed in the Class list can be generated based on the Class Name format. In the example shown in FIG. 3J, the Class Name Format is “<blank>Course ID‘-’Course Name‘-’Section<blank>[none]”. In the Class List shown in FIG. 3E, the classes in the list belong to Course ID=MIS; the Course Names are 180, 358, and 191; the Sections are A, C and E.

Certain tasks and/or task groups can receive system generated alerts. The alerts assist faculty members in pin-pointing tasks which need to be addressed.

Alerts can take two forms, depending on the page being viewed. In the General view, alerts are single line, general information, for example, “New Journal entries have been posted.” On the task group page, alerts can be more specific, for example, “5 new Journal entries have been posted for class MIS-180-A.” Multiple alerts can be posted on the task group page. On the other hand, a single alert is posted to the General view, stating “Tasks require your attention.”

The alerts can be hot clickable to launch the appropriate task. In the case of the alert “Tasks require your attention”, clicking on this alert route the user to the task group page.

Once a user selects a class (or classes) for which a task is to be performed, and clicks on the selected task, the user navigates to the specific task work page. The appearance of the task work page can take one of multiple forms, depending on the nature of the task.

In the default view for tasks which cannot be performed across multiple classes Simultaneously, a radio button controlled listing of the selected classes and work space of the task is provided. A Printable Format button and a Toggle Search button are provided in the view (FIG. 3K). Any searches are conducted within the context of the class. Any task that defaults to Simultaneously also has Individually available.

The classes selected on the primary Faculty Workstation page are listed on the work page under “Selected Classes”. By default, the first class is selected (radio button on). The user can switch between classes by selecting the appropriate radio button.

For those tasks which can be performed across multiple classes, simultaneously (for example, posting an announcement that office hours are changing) a single, cross-class view is provided (FIG. 3L). A defined search is performed across all selected classes.

The selected classes appear in a listing under the heading “Selected Classes” (FIG. 3L). On any given work page viewed in this mode, upon the selection or de-selection of a class, a refresh of the page can be generated to reflect only those classes that are checked (selected). When performing a given task in simultaneous mode, the user can de-select a class to which the user does not want the task to be applied (that is, working on a subset of the initial selection). Each task that is launched starts, however, with all of the initially selected classes (from the Class Selection pane) selected by default.

The user can switch between Modes (that is, Simultaneously and Individually) by using a drop-down menu (FIG. 3L), allowing for additional flexibility and functionality for performing same task which has different “details” based on the class (for example, uploading files to the Shared Files folder of each class where different files need to be uploaded for each of the classes). In the event that a selected task is not available or cannot function in the multiple class scenario, the Mode drop-down box is not displayed.

For those tasks with both views available, the default is, usually, View Classes Simultaneously. However, users may have a desire to work in the Individually mode more often than in Simultaneously mode. The Faculty Workstation provides a “save view” option to the user, on each task work page main page to allow the user to select his/her own default view for a particular task. In addition, the Faculty Workstation can remember or register the last view used by the user and the last view is only activated if (i) the user has not selected a “personal default view” and (ii) the system default view was not the last one used by the user. Therefore, the hierarchy becomes the following: (a) user selected saved view; (b) last view used; and (c) system default view.

In the examples of FIGS. 3K and 3L, a navigation menu can be provided on the left side of the page (above the Selected Class listing) for shortcut access to the complete task group, including the task that is currently being worked, without descriptions and without alerts, in either mode (Individually or Simultaneously).

A discussion of exemplary tasks and task groups which may be included in a default view of the Faculty Workstation is discussed below. It should be apparent to one skilled in the art, however, that other tasks and task groups can also be provided by the Faculty Workstation, and that the grouping of tasks can of course be different from the examples discussed herein, without departing from the spirit and scope of this disclosure and the appended claims.

The Assignments task group page can include several tasks (for example, FIGS. 3B, 3E, 3K and 3L), including one or more of the following: view and manage Assignments; generate and add new Assignment; find an Assignment; set Assignment settings; check homework submissions; send reminders; etc.

In the Assignments task group box, general alerts are provided, such as “Assignments have been submitted.” However, on Assignments task group page, more specific alerts are provided, such as “3 Assignments have been submitted for MIS-180-A.” This alert is posted for each selected class. For example, if assignments have been posted in three classes, three separate alerts can be presented on the page (one alert for each class).

A View/Manage Assignments page (for example, FIG. 3M) may be provided for viewing all assignments listed in the selected classes, and modifying classes Individually or modifying classes Simultaneously. Generally, assignments, tests, quizzes, exams, etc., can be added or modified to classes individually or simultaneously. A column is provided for indicating for each Assignment the classes for which that Assignment is posted. By default, the Assignments are sorted by class (with the Assignments listed in order as defined in the class data). In Simultaneous mode, new identical entries can be created for each selected class. Each entry can then be individually modified from the View/Manage Assignments page, if necessary. In “Individual” mode, the appearance of the table changes (for example, each class is tabbed), and the Class column is hidden (and “Search by Class” is hidden, since the search by definition is within the selected class). A search facility (Toggle Search button) is provided to allow for search by Title, Class, Available Date (range, Due Date (range), etc. Multiple search criteria entry (multiple fields to search on) can be provided to the user, to enable finely granular search results, as much as possible.

The user can select (by checking checkbox) one or more of the displayed Assignments, and then select an Action on Selected Items, using the drop-down menu. Choices of actions include delete item, edit basic information, add to Gradebook, remove from Gradebook, add to Assignments, remove from Assignments, publish grades, unpublish grades synchronize existing elements, etc.

Selecting Add New Assignment from the task group page is equivalent to selecting New Entry” from the View/Manage Assignments work page. Selecting “Add New Assignment” (from the task group page) or clicking the New Entry button (from “View/Manage Assignments” page) launches an Assignment Editor page (FIG. 3N). Selected classes are shown towards the top of the Assignment Editor page. In Simultaneous mode, once Save Assignment is selected, the system create the assignments in each of the selected classes, and returns to the View/Manage Assignments page in order to allow confirmation by the user.

Selecting Assignment Wizard from the View/Manage Assignments work page allows the user to create an assignment series to individual selected classes or selected classes simultaneously.

The user can select Homework Submissions to launch a page (for example, FIG. 3P) for collecting (and then downloading) selected Assignment Submissions (for example, creating a ZIP file with a directory structure in the form of \Class\Assignment\Student\file). In the default flow, the user selects the class, selects the assignment (from the drop down), select the student submissions, click Add Selected to Download Basket, then move on to the next class, repeat the steps, and so on until all classes for which the user wants to download homework submissions have been addressed, then select Download Now to have the ZIP file generated. The user can of course select Download Now after each iteration (that is, class selection, assignment selection, student submission selection) allowing the user to create separate ZIP files, if so desired.

When the user selects a class, the assignment listing for the selected class is loaded into a drop-down box requiring the user to select a specific Assignment for addition to the shopping cart. When an Assignment is selected from the drop-down, the screen is refreshed with the listing of students in the class along with, for each student, the student's submission status of each assignment. The page can also include an indication of those assignments which have already been graded (not shown in FIG. 3P), to save the faculty member some time during the selection and download generation process.

The Gradebook task group page can include task entries for Open Gradebook, Add New Gradebook Item, Publish/Unpublish a Grade, Find a Grade Entry, etc. A Gradebook is tied directly to a class, that is, its data is only relevant within the class, and therefore it is used in Individual Mode. The faculty user focuses his/her workflow on the task of maintaining records in the gradebooks of each of his/her classes.

Open Gradebook is invoked to view and update gradebook items. Selection of Toggle Search launches a search box with search criteria options allowing search by Title, Student, and/or Published/Unpublished/All (drop-down).

Add New Gradebook Item is selected to add new gradeable item(s) into a Gradebook. In this example, Gradebook items are actually added via the Assignments tools, and therefore selecting Add New Gradebook Item navigates to the Assignment Editor. Add New Gradebook Item can be used in Simultaneous mode to create identical items in the gradebooks of all selected classes.

Publish/Unpublish a Grade makes grade(s) viewable or nonviewable to students. The Publish/Unpublish a Grade page (FIG. 3Q) presents a table with each row shown with identification of item (assignment, quiz, test, exam, etc.), corresponding class, corresponding grade, and a selection check box. Selection of publish or unpublish is controlled via a drop-down box.

The Announcements task group can include task entries for View/Edit Announcements, Post Announcement(s), Repost Announcement(s), and Find Announcements.

View/Edit Announcements can be selected to view and edit class announcements, in a manner similar to View/Manage Assignment for managing assignments, with both Individual mode and Simultaneous mode being available. The Toggle Search button on the View/Edit Announcements page (FIG. 3R) allows similar, multi-field search capabilities and launch a search box with search criteria options allowing search by Subject, Class, Posted (date range), Expired (date range), and/or Status (drop-down). New Announcement can be selected to launch an Edit Announcement page (similar to Assignment Editor).

Post Announcement(s) can be selected to create and post new announcement(s), and when Post Announcements is selected a view of the New Announcement screen is launched. Class selection at the top of the page specifies the classes to which the announcement are posted. As with Assignments, the user can de-select any of the selected classes to not post to the de-selected class. In a preferred implementation, only a single announcement is created and stored in the system, and it is linked to each of the classes selected.

Repost Announcement(s) returns a listing of announcements that have expired, and allows the user to update, re-post or delete the expired announcement.

Find Announcements provides a Search Criteria box providing criteria for user entry, announcements are searched based on the user-entered criteria (with multi-criteria possible), and a page similar to View/Edit Announcements (FIG. 3R) is returned.

The Activity Tracking task group includes View Student Activity and Find Students. View Student Activity enables the faculty member to view selectable summary information (from amongst Assignments, Announcements, Gradebook, Message Board, Shared Files, etc.) of student access to tracked areas. Find Students allows the faculty member to find specific student(s) by name, class, dates, and/or tracked areas. The baseline for the search criteria is Student, Class, Date (range), and/or Item(s). The Item criteria does not limit the display to the selected tools, only to provide a limiter on areas accessed as a search criteria. For example, if the faculty only wants to see the activities of those students who have accessed Gradebook, a student who has not accessed Gradebook is not listed in the displayed list.

The Syllabus task page includes View Syllabus, Create Syllabus, Edit Syllabus and Delete Syllabus.

View Syllabus enables the faculty member to view the course syllabus of selected classes. The faculty member can use Create Syllabus to create a syllabus for a single class or a baseline syllabus for multiple classes. Edit Syllabus enables the faculty member to update or revise the course syllabus.

In Simultaneous mode, Create Syllabus launches the Edit Syllabus screen to enable the faculty user to create a “baseline” or generic syllabus for multiple classes. The Edit Syllabus screen can offer the option of uploading a file (as the syllabus). A pop-up confirmation can be provided, informing the user that the selected file, upon confirmation, will be uploaded to the syllabus area for each of the selected classes, as follows:
The file you have selected will be uploaded to all of the classes you have currently selected. Select OK to proceed or CANCEL to change your class selection.
[OK] [Cancel]

This is necessary, as there may be information specific to each of the classes which is different (example specific schedule dates).

If the user has chosen to work in Individual Mode, the file upload is only applied to the class on which the user is currently working and the confirmation pop-up is not required.

Delete Syllabus can be selected to delete the current syllabus from selected classes. Delete Syllabus is a back-end function which deletes the syllabus information (or uploaded files) from the course content of the classes that are selected. The following confirmation pop-up can be displayed:
You are about to delete all syllabus information or files from the selected classes. Are you sure?
[Yes] [No]

The E-Mail Members task group includes E-Mail All Members and E-Mail Selected Members. E-Mail All Members enables the faculty member to send an e-mail to all members of selected classes. E-Mail Selected Members can be selected to send e-mail to selected members of selected classes. A member directory (an aggregate listing of all of the members of the selected classes) is displayed.

The Shared Files task group includes Upload New Files, View/Manage Files and Folders, and Find a File.

Upload New Files allows the faculty member to upload new files to the Files Home (root) folder of selected classes. Upload New Files launches a File Upload pop-up (FIG. 3S). The faculty user selects Folders to which a file is to be uploaded. In the example of FIG. 3S, the faculty user adds a folder to Selected Folders by clicking the folder name in the folder tree. To choose a folder in a different class, the user uses the Available Classes drop down to switch to a different class. After selection of folders is complete, the “Upload file” button is clicked to upload the file to the Selected Folders.

View/Manage Files and Folders enables the faculty member to view and manage Shared Files repositories of selected classes.

Find a File can be used to search for a file, by name, in the shared folders of selected classes. Find a File launches a search screen, allowing the user to search for a file by name (or partial name text) across all selected classes. The returned display (FIG. 3T) lists the files matching the criteria, class, folder, size, and last modified information (sample table, below). Clicking on an icon returns the details pop-up. Clicking on a file name launches the file (based on browser settings). Clicking on a class causes the Shared Files page (Files Home page) of the class to be launched. Clicking on a folder name takes the user to the folder in the Shared Files area of the class.

The Calendars task group includes View Schedules (for viewing calendar events of selected classes), Post New Event (for posting events to calendars of selected classes), Manage Calendars (for setting or modifying calendar settings and access controls), Find Events for searching class calendars for events, by title, and/or date range.

The Discussion Forums task group includes View Latest Messages, View/Manage Forums, Forum Editor, Default Settings, and Find Messages. View Latest Messages launches the current Discussion Forums (Message Board) application, defaulting to “Latest Messages” tab. View/Manage Forums enables the faculty user to view Discussion Forums, and a column needs to be added to the display table indicating the class which is home to the forum. An Add Topic To Checked button is provided on the page (FIG. 3U) for launching a Topic Editor screen, allowing the user to add an identical topic to each of the selected forums. Add New Forum allows the user to create a new discussion forum. Forum Editor can be launched in Simultaneous mode to create identical forums in each of the selected classes. Default Settings allows the user to set the default view of discussion forums. Discussion Forums (Message Board) Settings can be launched in Simultaneous mode to set the default display (by date/thread) for the discussion forums in each of the selected classes. Find Messages enables the user to search for message board postings by forum, topic, and/or author across all selected classes.

The Journal task group includes View Latest Journal Entries, View Journals, and Find Journal Entries.

View Latest Journal Entries launches the current Journal Viewer, defaulting to the “Latest Messages” tab. View Journals launches the Journal Viewer, defaulting to the “Forums” tab. Find Journal Entries allows the faculty member to search for journal entries by student, topic, and/or author.

The above specific embodiments and examples are illustrative, and many variations can be introduced on these embodiments and examples without departing from the spirit of the disclosure or from the scope of the appended claims.

For example, some of the various types of informational content referenced in connection with the discussions of exemplary embodiments and examples above include: assignments; announcements; schedules; academic discussion forums; student journals; gradebook; lessons; syllabus; attendance records; shared files; bookmarks; e-mails; journal entries; and summary of student access to tracked areas. However, it should be appreciated that the subject matter of this disclosure is not limited to performing tasks on only these types of content, but can be extended to other types of content as well.

Further, only some exemplary user interface screens are provided in the drawings to introduce some examples of tasks that can be performed through the subject matter of this disclosure, including user interface features to enable the faculty user to add, build, copy, create, delete, edit, find, generate, import, manage, open, post, provide, publish, rename, unpublish, update, upload and view content, as well as set defaults for operations. In the interest of brevity and conciseness, not all of the tasks that can be performed for each type of content is described above. However, it should be appreciated that a task that can be performed for one type of content, as discussed herein, in many instances can also be performed for other types of content in a similar manner.

In addition, it should be appreciated that elements and/or features of different examples and illustrative embodiments may be combined with each other and/or substituted for each other within the scope of this disclosure and appended claims.

What is claimed is:

1. An apparatus for faculty members of an educational community to access and modify content of a plurality of academic courses, the apparatus comprising:
a user interface configured to display a class list and a list of tasks and enable a user to select a plurality of classes from the class list and select a task from the list of tasks; and
a processing part configured to perform the selected task for each of the plurality of selected classes.

2. The apparatus of claim 1, wherein the processing part performs the selected task for the each of the plurality of selected classes in turn, in response to user entry of a single command through the user interface.

3. The apparatus of claim 1, wherein the selected task is performed simultaneously for the each of the plurality of selected classes, in response to a single command from the user through the user interface.

4. The apparatus of claim 1, wherein the user specifies through the user interface informational content to be uploaded by the processing part, and the uploaded informational content is posted to course content for the each of the plurality of selected classes, in response to a single command from the user through the user interface.

5. The apparatus of claim 1, wherein informational content is entered by the user through the user interface, and the informational content is posted to course content for the each of the plurality of selected classes, in response to a single command from the user through the user interface.

6. The apparatus of claim 1, wherein the user specifies through the user interface an element or component to be included in course content of the each of the plurality of selected classes, and the processing part synchronizes the specified element or component across the course content of the each of the plurality of selected classes.

7. The apparatus of claim 1, wherein the user interface provides the user with means to specify that only tasks that meet a predetermined criteria are displayed.

8. The apparatus of claim 1, wherein the selected task, selected through the user interface and performed by the processing part for the each of the plurality of selected classes, includes performing one or more of the following actions to informational content: add; build; copy; create; delete; edit; find; generate; import; manage; open; post; publish; rename; unpublish; update; upload; and view.

9. A system for faculty members of an educational community to access and modify content of a plurality of academic courses, comprising:
a remote computer configured to maintain a database for the plurality of academic courses; and
one or more information terminals, each information terminal including:
a processing part configured to process information for communication with the remote computer through a network; and
a user interface configured for display of a class list and a list of tasks, based on data received from the remote computer, and for user selection of a plurality of classes from the displayed class list and user selection of a task from the displayed list of tasks, and
wherein in response to user entry of a single command through the user interface, the processing part of the information terminal causes data indicating the selected task and the plurality of selected classes to be communicated to the remote computer, and the remote computer performs the selected task to course content for each of the plurality of selected classes.

10. A method for enabling faculty members of an educational community to access and modify content of a plurality of academic courses, the method comprising the steps of:
(a) receiving user selection of a plurality of classes selected from a class list via a user interface;
(b) receiving user selection of a task selected from a task list via the user interface; and
(c) performing the selected task for each of the plurality of selected classes.

11. The method of claim 10, further comprising:
receiving a single command from the user,
wherein the selected task is performed in step (c) for the each of the plurality of selected classes in turn, in response to the single command from the user.

12. The method of claim 10, wherein the selected task is performed simultaneously for the each of the plurality of selected classes in step (c), in response to a single command from the user.

13. The method of claim 10 further comprising:
receiving user-entered informational content, and
wherein the selected task performed in step (c) includes posting the informational content to course content for the each of the plurality of selected classes.

14. The method of claim 10 further comprising:
uploading informational content, and
posting the uploaded informational content to course content for the each of the plurality of selected classes, in response to a single command from the user.

15. The method of claim 10 further comprising:
displaying a list of academic terms for user selection;
receiving user selection of one or more terms from the list of academic terms;
compiling the class list based on the one or more user-selected terms; and
displaying the class list through the user interface and allowing the plurality of classes to be selected by the user from the class list via the user interface, prior to the step (a).

16. The method of claim 10 further comprising:
displaying informational content for user selection and modification through the user interface, wherein the displayed informational content includes one or more of: assignments; announcements; attendance records; academic discussion forums; bookmarks; e-mails; gradebook; lessons; schedules; shared files; student journals; syllabus; journal entries.

17. The method of claim 10, wherein the selected task performed in step (c) includes adding, editing or deleting one or more of the following content elements for said each of the plurality of selected classes: an assignment; an announcement; an attendance sheet; a bookmark; a discussion forum; an e-mail; an event; a gradebook item; a journal entry; a lesson; a message board topic; a schedule; a shared file; a syllabus.

18. The method of claim 10 further comprising:
performing a search for informational content specified via the user interface, in course content for the each of the plurality of selected classes, wherein the search is based on a specified combination of search terms in multiple specific search fields.

19. The method of claim 10, wherein the task list includes a plurality of task groups, and user selection of the selected task is received in step (b) after one of the plurality of task groups is selected through the user interface.

20. An information terminal configured for a faculty member of an educational community to access and modify content of a plurality of academic courses, comprising:
a processor; and
a program storage device readable by the computer system, tangibly embodying a program of instructions executable by the processor to perform the method claimed in claim 10.
